(19) United States
(12) Patent Application Publication
(10) Pub. No.: US 2014/0306565 A1
(43) Pub. Date: Oct. 16, 2014

(54) Coaxial Motor

(71) Applicant: Harry K. James, Orange, CA (US)

(72) Inventor: Harry K. James, Orange, CA (US)

(21) Appl. No.: 14/213,132

(22) Filed: Mar. 14, 2014

Related U.S. Application Data
(60) Provisional application No. 61/791,031, filed on Mar. 15, 2013.

(51) Int. Cl. H02K 17/18; H02K 7/08

(52) U.S. Cl. CPC H02K 17/185; H02K 7/08
USPC 310/90

(57) ABSTRACT

An electric motor design is described including coaxial, concentric multiple cylindrical stators and rotors with air gap registration maintained and rotor rotation and fixed stator position facilitated by use of one or more precision bearings mounted on a common shaft. The multiphase stator winding routing is facilitated by the use of multilayer printed circuit boards to allow multiphase excitation of the stator winding to provide induction motor drive to the rotor. The rotor is a double squirrel cage design that allows supplemental resistors and inductors to augment the construction materials inherent physical resistance and inductance of the squirrel cage. The design is further enhanced for high torque startup by construction superposition of a reluctance motor feature incorporated into the squirrel cage rotor construction.

### BACKGROUND

The design of electric motors has not fundamentally changed in more than 100 years. Demand for electric motors has driven a desire for higher torque, higher efficiency, lower operational cost and and reduced size without sacrifice in any of the requirements. Advanced designs to meet these objectives would be welcomed.

### BRIEF DESCRIPTION OF DRAWINGS

FIG. 1 is a simplified diagrammatic illustration of an exemplary embodiment of a squirrel cage induction motor with an outside stator configuration.

FIG. 2 is a simplified diagrammatic illustration of an exemplary embodiment of a squirrel cage induction motor with an outside rotor configuration.

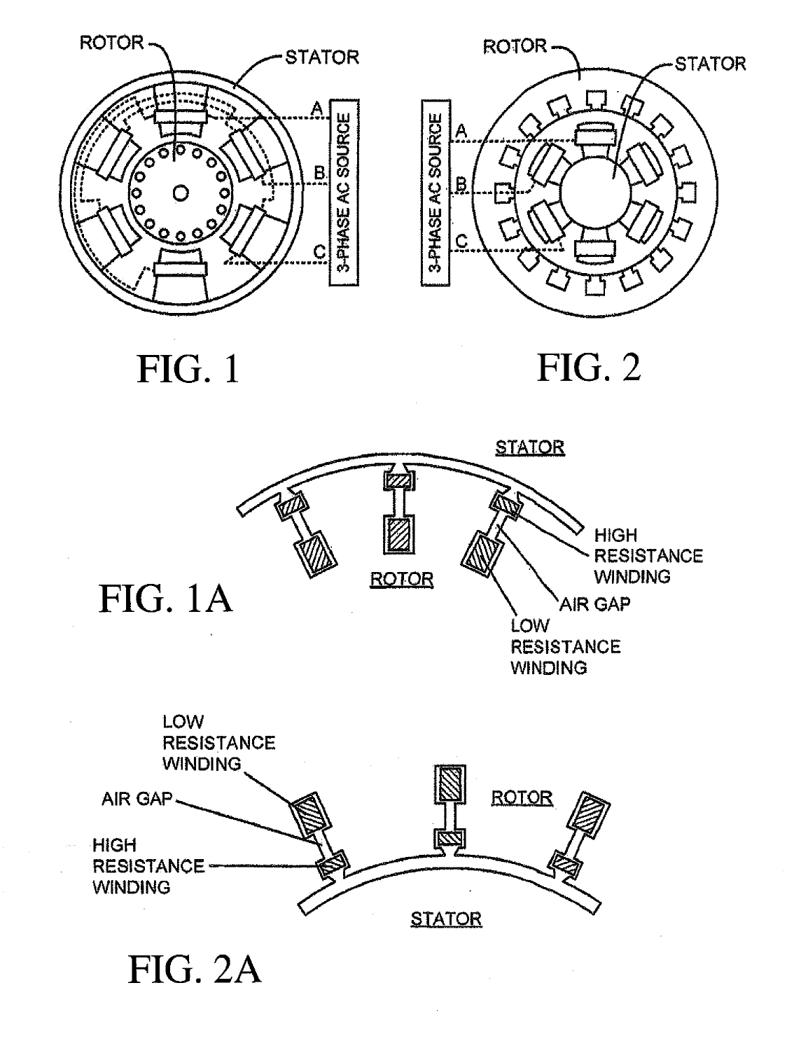

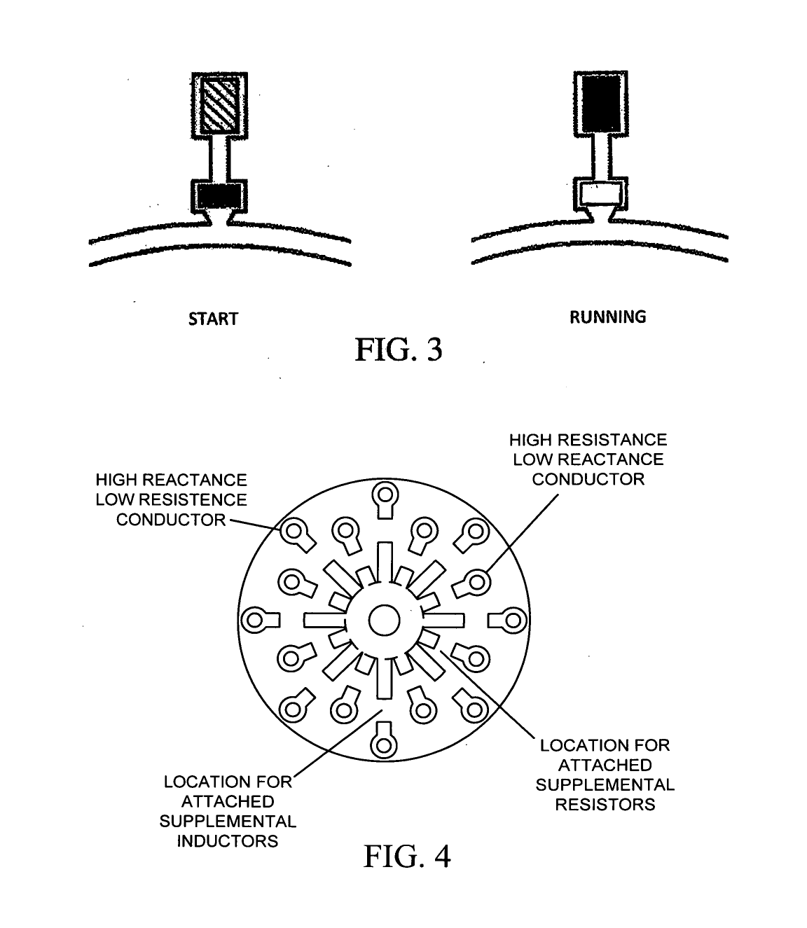

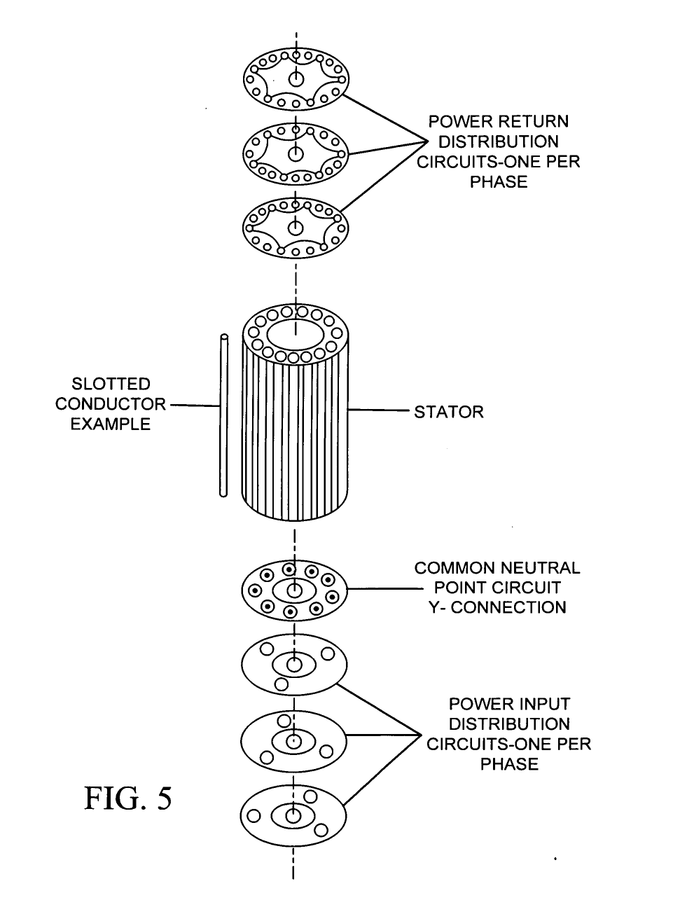

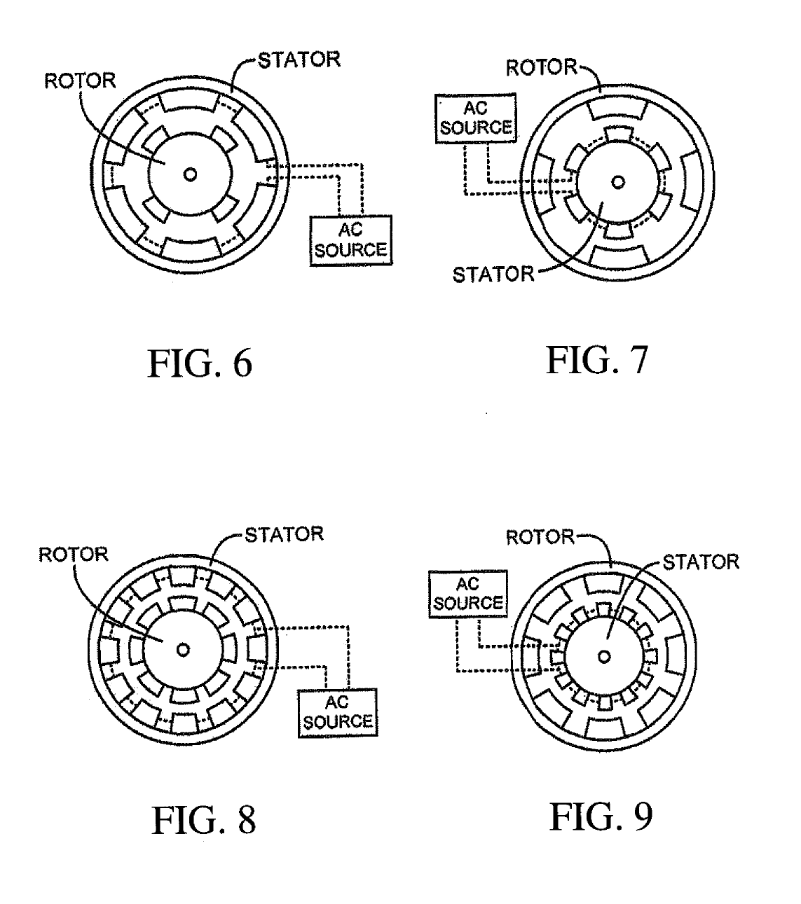

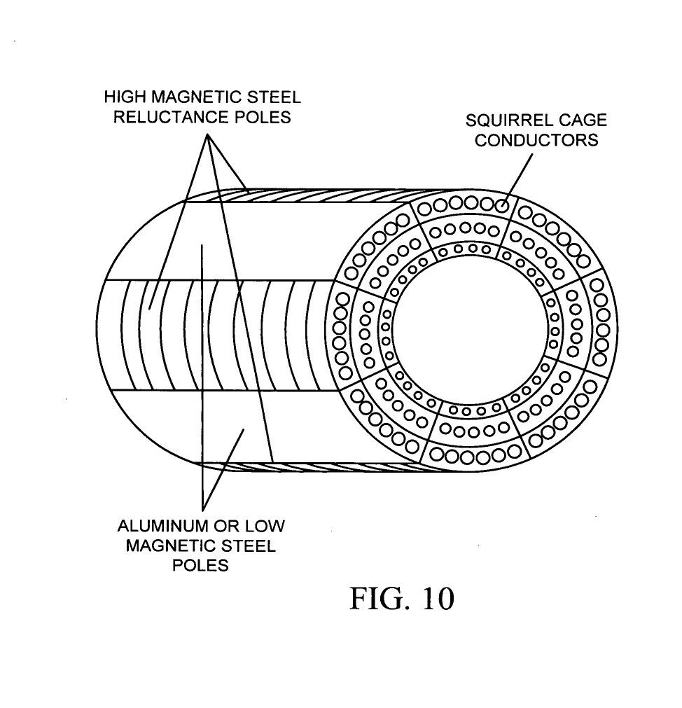

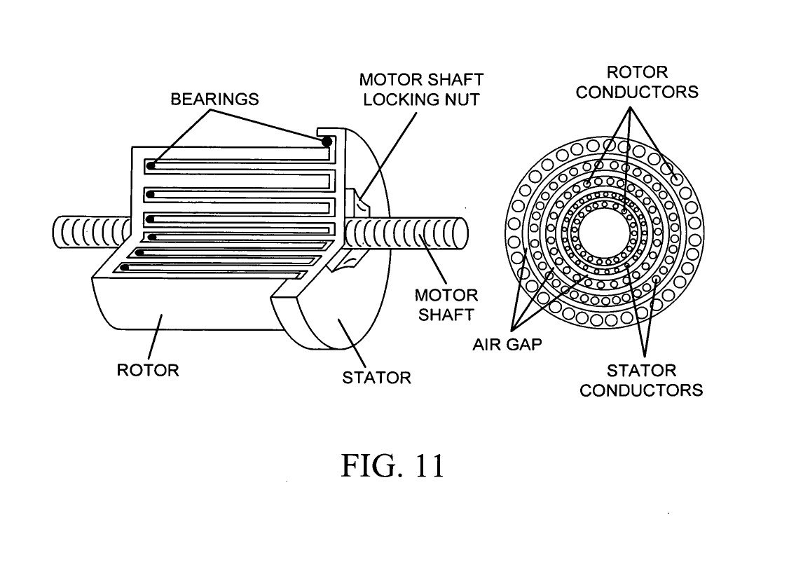

FIGS. 1A and 2A illustrate configurations of Class C rotor windings for a stator outside configuration and a rotor outside configuration, respectively.

FIG. 3 is a simplified diagrammatic illustration of an exemplary double squirrel cage rotor indicating relative current densities in the double squirrel cage winding at start-up and running conditions, respectively.

FIG. 4 is a simplified diagrammatic illustration of an exemplary end ring design for a double squirrel cage rotor with options to attach supplemental resistors and/or inductors.

FIG. 5 is a simplified diagrammatic illustration of an exemplary 3-phase stator configuration with printed circuits replacing the classical “overhang” winding coil routing.

FIGS. 6-9 depict exemplary embodiments of switched reluctance motors. FIG. 6 illustrates the embodiment of a 6/4 switched reluctance motor with stator outside configuration. FIG. 7 illustrates the embodiment of a 6/4 switched reluctance motor with the rotor outside configuration. FIG. 8 illustrates the embodiment of a 12/8 switched reluctance motor with stator outside configuration. FIG. 9 illustrates the embodiment of a 12/8 switched reluctance motor with the rotor outside configuration.

FIG. 10 is a simplified diagrammatic illustration of a virtual switched reluctance rotor superposed with a double squirrel cage rotor configuration.

FIG. 11 is a simplified diagrammatic illustration of the coaxial motor with pluralities of concentric rotors and stators.

### DETAILED DESCRIPTION

An induction motor is one in which alternating current is supplied to the stator directly and then to the rotor by induction or transformer action from the stator. When excited from a balanced polyphase source, a magnetic field will be produced in the air gap rotating at synchronous speed as determined by the number of poles and the applied stator excitation frequency. The essential feature that distinguishes the induction machine from other types of motors is that the secondary currents are created solely by induction, as in a transformer, instead of being supplied by a direct current exciter or other external power source as in synchronous or direct current machines.

The rotor of a polyphase induction machine may be of one of two types: (1) wound rotor or (2) squirrel-cage rotor.

A wound rotor is built with a polyphase winding similar to, and wound with the same number of poles as, the stator. The terminals of the rotor winding are connected to insulated slip rings mounted o the shaft. Carbon brushes in bearing contact with these rings make the rotor terminals available external to the motor. Wound rotor induction machines are relatively uncommon and are found in only a limited number of specialized applications. Therefore, this will not be a significant focus of this discussion.

A typical polyphase squirrel cage motor consists of a winding with conducting bars embedded in slots on the periphery of the rotor iron core and short-circuited at each end by conducting end rings. The squirrel-cage induction motor is comparable to a transformer with a rotating secondary. The extreme simplicity and inherent ruggedness of the squirrel-cage construction are outstanding advantages of this type of induction motor and make it, by far, the most commonly used type of motor in sizes ranging from fractional horsepower and larger.

Please refer to FIG. 1 (stator outside) and FIG. 2 (rotor outside) that depict squirrel cage induction motors.

The rotor core is constructed of steel laminations, and the conductor bars are placed in the slots approximately parallel to the shaft. The joints between the bars and rings are usually electrically welded into one unit. In small squirrel-cage rotors, the bars and end rings are of aluminum cast in one piece instead of welded together.

The core of the rotor of the squirrel-cage motor is constructed of steel laminates. The material is usually the same as that used for the stator. There can be less laminates and they can be thicker without producing excessive eddy currents and hysteresis losses, due to the lower frequency of the rotor's magnetic flux. Slots on the rotor are normally arranged in a diagonal fashion, or skewed. This minimizes the noises due to the magnetizing forces and smooths torque variations.

The number of rotor slots is never the same as the number of stator slots. There may be more or less slots on the rotor, but the number will never be an equal multiple or division of the number of stator slots. This requirement eliminates dead spots or points of zero torque which would inhibit rotation.

Rotor conductors may be round, square or rectangular. They are made of copper, aluminum or brass. The rotor conductors are inserted in slots of the core and are not insulated from the core, since the induced voltage into the conductors is seldom greater than 10 volts and, in most cases, it is considerably less.

For existing design and production techniques, resistance and inductance of the squirrel-cage rotor is not variable. These characteristics are determined by the design of the rotor and it is set at the time the motor is produced. The amount of rotor resistance and inductance is determined by the design engineer based on the motor's application. Under the current design restrictions, the exact rotor resistance value depends on the characteristics of the conductors. Resistance varies with the type of material used, the length of the conductors and their cross-sectional area. Inductance of the rotor can be changed by using slots of different dimensions. A deep slot produces greater inductance than a shallow slot

The air gap between the rotor and stator must be very small in order for the best power factor to be obtained. The shaft must, therefore, be very rigid and furnished with the highest grade of bearings, usually of the sleeve or ball-bearing type. The air gap is the radial distance between the rotor and the stator. Because the magnetizing field of the stator tends to confine itself to the iron of its magnetic circuit, it requires a magnetizing force (ampere-turns) several times greater to cross the air gap to the rotor. The increased current needed to produce this field lags the voltage by 90° and is mostly wattless power. This lowers the overall efficiency of the machine. For this reason, the air gap is kept as small as possible.

For a polyphase winding in a squirrel-cage motor, the squirrel-cage winding takes the place of the field winding in a synchronous motor. As in a synchronous motor, the currents in the stator creating a rotating magnetic field. This field is produced by increasing and decreasing currents in the stator windings. When the current increases in the first phase, only the first of the independent windings produces a magnetic field. As current decreases in the first winding and increases in the second winding, the magnetic field shifts until the magnetic field is produced by the second winding. When the third winding has maximum current flowing in it, the magnetic field is shifted again. The windings are so distributed that this shifting is uniform and continuous. It is this action that produces a rotating magnetic field.

As the field rotates, it cuts the squirrel-cage conductors, and voltages are created in them. These voltages cause currents to flow in the squirrel-cage circuit-through the bars under the adjacent south poles into the other end ring, and back to the original bars under the north poles to complete the circuit.

The current flowing in the squirrel cage, down one group of bars and back in the adjacent group, makes a loop that establishes magnetic fields in the rotor core with north and south poles. The poles in the rotor are attracted by the poles of the rotating field set up by the currents in the armature winding and follow them around in a manner similar to the way in which the field poles follow the armature poles in a synchronous motor.

There is, however, one interesting and important difference between the synchronous motor and the induction motor: the rotor of the induction motor does not rotate as fast as the rotating field of the armature. If the squirrel cage was to rotate as fast as the rotating field, the conductors in it would be standing still with respect to the rotating field, rather than cutting across the magnetic field lines of flux. Then there would be no voltage induced in the rotor conductors and therefore no attraction between the rotor and rotating field in the stator and thus no torque to rotate shaft and its attached load.

In the squirrel cage motors previously described, the rotor winding is practically self-contained; it is not connected either mechanically or electrically to outside power supply or control circuit. It consists of a number of straight bars uniformly distributed around the periphery of the rotor and short circuited at both ends by end rings to which the bars are integrally joined. Since the rotor bars and end rings have fixed resistances, such characteristics as starting and pull-out torques, rate of acceleration and full-load operating speed cannot be changed for a given motor installation.

NEMA Class C (high torque, low starting-current) motors are usually equipped with a double squirrel cage winding and combine high starting torque with low starting current. These motors can be started at full voltage. The low starting current is obtained by design to include inherently high reactance. The slip at rated load is relatively low.

Two sets of bars are used, with the inner bars (for the less common inside out rotor design) having a high resistance to produce a high starting torque with a low starting current. At running speed, nearly the entire rotor current flows in the outer windings.

Please refer to FIG. 1A (stator outside) and FIG. 2A (rotor outside) for a depiction of this effect.

From the shape of the rotor slots, it is apparent that the bars on the outer cage (furthest away from the stator-rotor air gap) are surrounded entirely by iron except for the constricted portion of the slot between the two cages that constitute another air gap. The bars of the inner cage (closest to the stator-rotor air gap) are surrounded by iron at the sides only, and hence two air gaps in the magnetic field around them; since this path is much less perfect magnetically than that around the outer conductors, its inductance is lower.

At the instant of starting, the rotating field of the stator current sweeps across both sets of rotor conductors at the full line frequency and induces currents in them. Since the inner conductors have a relatively low inductance, considerable current is set up, even at full line frequency. In the outer conductors, however, the current is greatly impeded by the combined action of the high reactance of this winding and the high frequency of the current. In fact, the choking action of the self-induction at line frequency is so great that very little current can flow through this winding at the start. (This assumes a reasonably high frequency alternating current; at low frequency, the self-inductance will not be as great and the current will be more evenly shared between the two windings based on their respective resistances). The relative density of the currents in the two sets of conductors is shown by the amount of shading, as depicted in FIG. 3.

As the rotor gains in speed, the frequency of the currents induced in it decreases and the relationship between the currents in the two cages gradually and automatically changes to that shown for the normal running speed. At this low frequency, the high inductance of the outer cage winding is of relatively little importance and produces little choking effect.

The resistances of the two cages are now the chief limiting factor in the rotor currents. Consequently, the outer low-resistance'cage carries most of the total rotor current, with the advantageous results noted above. The starting torque of the double squirrel cage motors is greater than that of the ordinary squirrel cage, but less than that of motors with a single high resistance squirrel cage winding.

### Rotor Design Contribution to the Design

In order to achieve the desired performance profile for the double squirrel cage rotor, the selection of winding conductor material, its physical size and the physical magnetic properties of the rotor laminate material can be limitations on the desired performance.

This design offers a means to overcome these limitations. The conducting end rings can be replaced by printed circuit boards to which the rotor bars are mechanically or metallurgically attached to the rotor bars at each end of the rotor. This allows passive or active components to be incorporated onto the printed circuit boards to augment and improve the control of resistance and inductance beyond the inherent capability of rotor materials of construction to provide in order to achieve higher performance. This technique can be used to alter the winding resistance and reactance. Through-hole or surface-mounted resistors and inductors can be soldered to the printed circuit board to achieve any desired resistance/reactance values for these two windings, thus providing much greater latitude of control.

FIG. 4 depicts an example of a printed circuit board configured to allow attachment of either or both resistors or inductors for this purpose.

### Stator Design Contribution to the Design

In the course of considering the specific character of the excitation coils of the stator winding, it is desirable to minimize the physical size of the coil “overhang.” The overhang is that part of the coil that does not contribute to magnetic induction on the rotor. It is the part of the induction motor excitation coil that loops over the ends of the armature stator to provide a return of the excitation coil on another part of the stator periphery. It thus provides continuity in the excitation loop but does not aid in the inducement of electrical current flow in the rotor. While electrical current flows in the overhang, the overhang at each end of the stator does not magnetically interact with the rotor. The overhang, however, does detrimentally contribute to both resistance and reactance and is a source of flux leakage, all of which negatively impact energy efficiency. The overhang takes up significant space in stator excitation coil construction regardless of the motor type (AC induction, DC brushed or brushless) that could be better utilized if a way was found to eliminate it.

Since space (volume) and electrical/magnetic losses should be minimized, it seems that the technique for continuity of the loop of an excitation coil might be improved by the use of a buss plate such as a printed circuit board at each end of the stator rather than a continuous loop of wire or other shaped conductor as has been done since motors and electrical generators were first constructed over 100 years ago. It should be emphasized that this approach has a beneficial effect on performance.

The concept of this design is to replace the overhang with rigid printed circuit boards with two (2) to three (3) ounces of copper on each side attached to a through-hole, with the hole riveted for contact to both sides of the printed circuit board and the winding mechanically attached or soldered to the rivet or plated-through hole of the printed circuit board, respectively. The routing of copper on the printed circuit board would allow continuity from one location on the stator to another location for the same phase for the return excitation current. The copper on the board can be separated to minimize eddy current losses.

A three-layer printed circuit board with each layer appropriately insulated/isolated from each other would replace the overhang for a 3-phase winding with one layer for each phase; they can be individual disks or multilayer fabricated printed circuit boards.

The circular printed circuit board disks are 2-oz+copper FR-4 laminate. Power input locations have pins/plugs attached for connection to external power. For stacked single layer circuit boards, the current return distribution printed circuit board disks can be identical using a “notching” or “keying” pattern in the center hole or periphery to determine the phase to which each individual disk is dedicated. The use of this printed circuit distribution design eliminates the classic coil wrapping that includes “overhang”, the wiring sections at the end of the motor or generator that do not contribute to the rotational torque but contribute to resistance, flux leakage and eddy current losses. Therefore, this design improves device performance by reducing resistance losses, flux leakage and eddy current losses.

FIG. 5 depicts a 3-phases, 6-pole stator. The scale of the drawing depicts one slot per conductor, but for large-scale diameter renderings, multiple adjacent slots could easily be used.

However, nothing prevents this concept from being adapted to the standard rotor-inside configuration or less-common rotor outside configuration for single or polyphase AC motor or generator designs.

The conductors are envisioned to be twisted, multiwire insulated wire conductors. Multiwire and insulated conductors reduce eddy current losses. The wire bundle is envisioned to have the insulation removed at each end of the conductor bundle sufficient only to allow conductor attachment to the end disks by soldering or welding to the discs. The conductors make contact with all disks for uniformity in disk manufacture and economic volume cost benefit, but are connected actively only to the disk required; other disks provide isolated, non-connected lands or pads to facilitate mechanical strength.

The fact that this concept provides parallel connection to the conductors contributing to magnetic induced torque should result in a reduction in resistance, allowing more current to flow through the conductors reducing I²R losses from that expected with the historically common series winding overhang wrapping technique. This concept should be more cost effective to manufacture and to repair should it fail in use.

This design includes multiple coaxial alternating rotors and stators. The design embodies a multiple coaxial alternating cylindrical rotors and stators effectively producing an equivalent single axial rotor and stator with a virtual length equal to the sum of the individual lengths of each pair of rotor and stator within the multiple coaxial construction. This increases the torque by a significant multiple, a very significant performance enhancement when compared to standard single axial rotor and stator configurations.

### Switched Reluctance Rotor Contribution to the Design

Typically, a switched reluctance motor is a doubly salient pole machine with phase coils mounted around diametrically opposite stator poles. Salient poles are opposing 2-pair sets of stator or field poles that are concentrated in a confined arc of a circle and are enwrapped by the winding. This is different from stator or field poles formed by distributing the windings in a series of slots over a round surface as described above for typical multiphase induction motor designs. Energizing a phase in a switched reluctance motor will cause the rotor to move into alignment with the stator poles in order to minimize the reluctance of the magnetic path. Simple but inherently reliable construction is the main advantage attributed to switched reluctance motors. For example, only steel laminations assembled on a shaft comprise the rotor, with no windings or cage as in induction motors.

Performance advantages include high-speed capability (100,000 rpm is not uncommon), efficiency over a wide speed/torque range, excellent heat and vibration tolerance, and high power density. Because the rotor is passive (it does not use energizing coils or permanent magnets), total energy input is reduced compared to other electric motor designs.

Switched reluctance motors use controlled magnetic attraction in the 6/4 arrangement (6 phase excited stator poles and 4 passive metallurgical magnetic rotor poles) to produce torque. Existing switched reluctance motors drives are unipolar, in that the voltages applied to the windings are of only one polarity. This is done to avoid shoot through problems in the power devices of the inverter. The 6/4 machine has a torque/speed curve similar to a DC series motor with a 4:1 constant power operating region. Torque ripple can be serious at low speed (20%). FIGS. 6 and 7 depict a switched reluctance motor with 6/4 configuration for stator outside and rotor outside, respectively.

However, there are significant problems associated with the use of switched reluctance motors. They rely heavily on control electronics to switch stator phases to produce a moving magnetic field. This requires rotor position feedback information to precisely time stator current pulses to maximize torque production. The design is also subject to detrimentally significant torque ripple and acoustic noise generation, both of which can be readily felt and heard, respectively, in a vehicle application. The ability of switched reluctance motors to produce high torque at low speeds (even at zero speed) leads to this downside effect. Phase-to-phase current pulses that generate torque also excite the motor mechanical structures causing hammering noise and torque ripple greater than competing electric motor configurations.

In an attempt to improve the switched reluctance motor drive, a 12/8 switched reluctance motors has been demonstrated with much smoother operation. Moreover, switched reluctance motors are excellent for use in hostile environments and can be potentially successful in heavy traction, where permanent magnet cost would preclude brushless DC motors. FIGS. 8 and 9 depict a switched reluctance motor with 6/4 configuration for stator outside and rotor outside, respectively.

Adding passive reluctance rotor poles to the rotor cylindrical, as depicted in FIG. 10, provides supplemental torque improvement to the basic induction motor design. This is accomplished by introducing sections within periphery of the rotor that have greater magnetic field response than would be utilized for the cylindrical rotor. For example, the six-pole cylindrical stator described above would incorporate four high magnetic steel sections evenly dispersed around the periphery of each double squirrel cage rotor. Torque performance would be driven not only by the double squirrel cage configuration but would also benefit from the toque developed by the incorporated reluctance poles of the rotor. This feature would enhance startup torque but would fade as the high reactance coils of the rotor become more dominant with increased rotational speed.

### Combined Features of the Design

The combined features of a coaxial motor including multiple concentric stators and rotors is depicted in FIG. 11. All of the advantages detailed above are incorporated in the design.

1. A coaxial motor comprising a plurality of concentric stators and rotors with stator-rotor air gap registration maintained using precision bearings.

2. The coaxial motor in claim 1 comprising an induction motor with a plurality of squirrel cage rotors and a plurality of stators excited with alternating current conductors.

3. The coaxial motor of claim 1 whose conducting rings for the plurality of rotors and alternating current windings of the plurality of stators are multilayer printed circuits that allow routing of single phase or multiphase excitation to be routed to create multipole excitation of magnetic fields.

4. The coaxial motor of claim 1 whose squirrel cage rotor circuit board end rings can accept attachment of supplemental resistors and inductors to overcome limitations inherent with physical characteristics of the materials of construction to achieve higher performance torque and electrical power efficiencies.

5. The coaxial motor of claim 1 wherein the plurality of stator printed circuit boards routing for excitation of stator conductors replace the classical “overhang” coil winding relieving the non contributory I²R resistance losses, coil reactance, eddy current losses, magnetic flux leakage and excessive spatial volume required for “overhang” routing.

6. The coaxial motor of claim 1 whose plurality of stators conductors comprise of twisted, insulated, multiwire conductors that reduce eddy current losses.

7. The coaxial motor of claim 1 whose plurality of concentric rotor and stators produces a motor with a virtual length that is a significant multiple of a motor constructed in a common single axial rotor-stator configuration with higher torque and efficiencies.

8. The coaxial motor of claim 1 whose plurality of superposed passive reluctance pole sections spaced around the periphery of the plurality of rotors provide a greater magnetic field response inducing higher torque.
